(19) United States
(12) Patent Application Publication
(10) Pub. No.: US 2013/0263025 A1
(43) Pub. Date: Oct. 3, 2013

(54) SYSTEM AND METHOD FOR PRESENTING CONTENT ASSOCIATED WITH A GEOBROWSER

(71) Applicant: Larry Allen Maddocks, Salt Lake City, UT (US)

(72) Inventor: Larry Allen Maddocks, Salt Lake City, UT (US)

(73) Assignee: Larry Allen Maddocks, Salt Lake City, UT (US)

(21) Appl. No.: 13/850,949

(22) Filed: Mar. 26, 2013

Related U.S. Application Data
(60) Provisional application No. 61/615,889, filed on Mar. 27, 2012.

(51) Int. Cl. G06F 3/048

(52) U.S. Cl. CPC G06F 3/048
USPC 715/760

(57) ABSTRACT

A system and a method for presenting content on a web browser is provided. The system includes at least one visual media module for allowing a user to present media content on a graphical user interface, at least one text module for allowing said user to present text content associated with said visual media module and a geobrowser module to show geolocations associated with either said at least one visual media module or said at least one text module.

### CROSS-REFERENCE TO RELATED APPLICATIONS

This application claims the benefit of U.S. Provisional Patent Application No. 61/615,889 filed on Mar. 27, 2012 which are hereby incorporated by reference.

### BACKGROUND OF THE INVENTION

1. Field of the Invention

The present invention relates to system and method for presenting content on geobrowser, and more particularly relates to system and method for presenting visual, audio and text while presenting content and locations in a geobrowser.

2. Detailed Description of Related Art

There are many tools available to enhance the experience of the internet user. This includes geobrowsers such as Google Earth and Google Maps. There are many tools which include the ability to view presentations such as movies and slideshows, and to create those presentations online. Further, the users are allowed to create avatars and objects to interact with each other in three dimensional virtual worlds.

Furthermore, various tools are available in the market for online education and for virtual tours associated with geobrowser but most of these tools are not organized to work with each other in a useful way and thus it is desirable to create a system that incorporates tools that empowers the user to organize media-rich content and present it and link it with other content in order to create a more interesting and useful browsing experience, which in turn may bring together communities of users who will help organize knowledge. Further, the system will help share knowledge, understanding, art, language translation, an enhanced experience for accessibility-challenged users, and a spirit of cooperation between people of various cultures.

### SUMMARY OF THE INVENTION

In accordance with the teachings of the present invention, a system and a method for presenting content to virtually fly to geographical locations through a geobrowser is provided.

An object of the present invention is to provide a system and a method with at least one visual media module, at least one text module and a geobrowser module associated with either visual media module or text module.

Another object of the present invention is to provide a system and a method with an audio module to provide audio associated with either text module or visual media module. Further, the another object of the present invention is to provide a system and a method with control buttons such as forward, backward, audio, grow and shrink button.

Another object of the present invention is to provide a system and a method with a chat module to allow said users to interact with each other over the network.

Another object of the present invention is to provide a system and a method as a mobile phone application executed by various computing devices.

These and other features, aspects, and advantages of the present invention will become better understood with reference to the following description. This summary is provided to produce a selection of concepts in a simplified form. This summary is not intended to identify key features or claimed features of the present invention, nor is it intended to be used to limit the scope of the claimed present invention.

### BRIEF DESCRIPTION OF DRAWINGS

FIG. 1 illustrates a block diagram of a system 100 in accordance with a preferred embodiment of the present invention;

FIG. 2 illustrates a schematic diagram of a system 200 for creating genealogical presentations in accordance with a preferred embodiment of the present invention; and

FIG. 3 illustrates a schematic diagram of the components in a network environment 300 in accordance with another preferred embodiment of the present invention.

### DETAILED DESCRIPTION OF DRAWINGS

While this technology is illustrated and described in a preferred embodiment, a system—and a—method for presenting content in a geobrowser that is associated with a predefined presentation may be produced in many different configurations, forms and computer languages. This is depicted in the drawings, and will herein be described in detail, as a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the technology described herein.

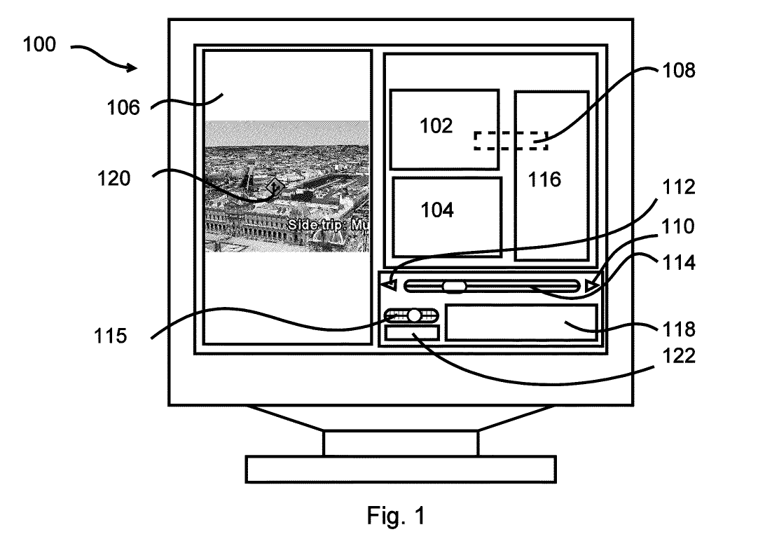

FIG. 1 illustrates a block diagram of a system 100 in accordance with a preferred embodiment of the present invention. The system 100 for presenting content includes at least one visual media module 102 for presenting visual media content on a graphical user interface, at least one text module 104 for presenting text content and a geobrowser module 106 to show geographical locations associated with either the visual media module 102 or text module 104.

In a preferred embodiment of the present invention, the visual media module 102 includes visual media content such as presentation or slideshow in the form of images and videos. The text module 104 includes text content such as text associated with the visual media module 102. The content displayed on the graphical user interface may include but not limited to slideshows, text presentations or videos.

In another preferred embodiment of the present invention, the system 100 includes an audio module 108 for providing audio associated with either the visual media module 102 or the text module 104 or in combination. The audio module 108 allows the user to hear the content presented by either text module 104 or visual media module 102.

In another preferred embodiment of the present invention, the system 100 includes one or more control buttons such as forward button 110, backward button 112 and a slide-bar to move the video forward and backward 114 and an audio button 115 to control the volume of the content played.

In another preferred embodiment of the present invention, the system 100 includes a chat module 116 for allowing users to interact with each other over the server. The chat module may be of various forms including but not limited to interactive forms, buttons, chat windows etc.

In another preferred embodiment of the present invention, the geobrowser module 106 includes a three-dimensional geobrowser such as provided by the google earth plugin, a two-dimensional geobrowser such as provided by google map, a satellite map, or a combination thereof. As shown in FIG. 1, the geobrowser module 106 indicates a three-dimensional image of the earth. This image shows the geographical location which is associated with the content in either the visual media module 102 or the text module 104. The geobrowser 106 visually flies the user to those geographical locations that are associated with the content displayed or heard.

In another embodiment of the present invention, the system 100 includes a side-trip presentation module 118 to allow a user to see other stored presentations. The side-trip presentation module 118 allows the user to see other stored side-trip presentations by clicking on a side-trip icon 120. The side-trip icon 120 is visible on the geobrowser module 106. When the user is finished watching a side trip, then the back button in the browser or the back button 112 allows the user to return to the original content displayed in either visual media module 102 or the text module 104.

In another embodiment of the present invention, the system 100 includes an option button 122 for allowing the user to have an option to choose links visible in the side-trip presentation module 118. In a preferred embodiment, the visibility may be determined by the user who creates the side-trip presentation module or by the user viewing the side-trip or by the sponsors who are underwriting the cost of producing the content.

In a preferred embodiment, when the content played is interrupted by another presentation such as a side-trip, the web page is not reloaded. The geobrowser is also not reloaded. Asynchronous JavaScript and XML (AJAX) technology is used to allow this to happen. With AJAX, web applications can send data to, and retrieve data from, a server asynchronously (in the background) without interfering with the display and behavior of the existing page.

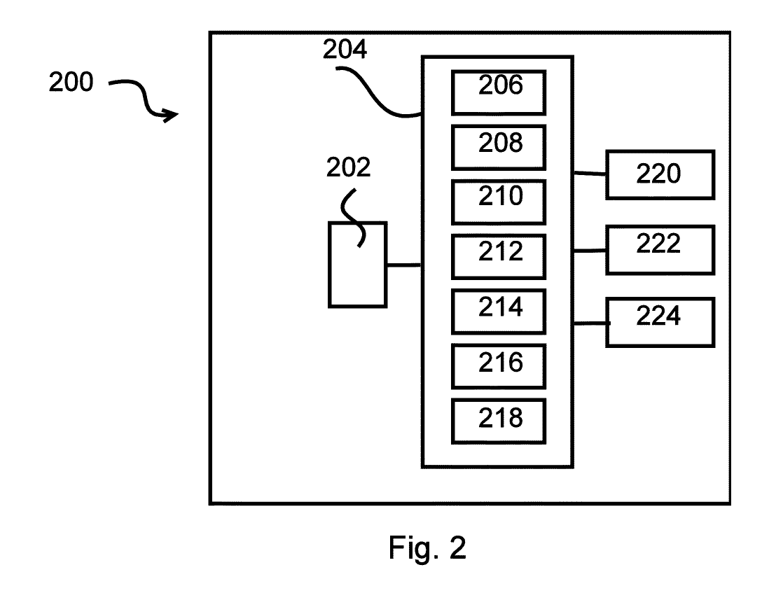

In another embodiment of the present invention, the system 100 includes a genealogy module to create genealogical presentation on the data provided by the user. The genealogy module is explained in detailed in conjunction with FIG. 2 of the present invention.

FIG. 2 illustrates a schematic diagram of a system 200 in accordance with a preferred embodiment of the present invention. The system 200 generates a genealogy presentation from the data 202 provided by the user. The genealogy data 202 assists family historians in tracking, organizing and sharing family history. The genealogy data 202 is passed on the presentation generation module 204. The presentation generation module 204 uses the information from the data and generates a presentation on the basis of the events occurred in the lives of ancestors and other related people in the family tree.

The presentation generation module 204 generates a genealogy presentation in the form of audio, video, photos or any other media dependent on the genealogy data 202. The presentation generation module 204 is further linked with the geobrowser. The geobrowser virtually flies to the geographical locations of the addresses of the events provided in genealogy data 202.

In another embodiment of the present invention, the presentation generation module 204 may gather data from various sources to be included in the presentation. As shown in FIG. 2, the presentation generation module 204 could look up images 206 of the birthplace. The user may choose from a list of images to include in the presentation. Also, the system 200 may include a community of users who volunteer to gather images and other assets and data to be used to create presentations.

In another embodiment of the present invention, the presentation generation module 204 may further include local historical events 208 and significant national and historical events 210. Further, the user genealogy data 202 may be used to generate audio speech 212. However, it is to be readily apparent to those skilled in the art that various forms of audio speech 212 may be used without deviating from the scope of the present invention.

In another embodiment of the present invention, the presentation generation module 204 may further include historical facts 214 for generating presentations. The historical facts 214 may include but not limited to homes, typical furnishings, fashions, sayings, popular books, political climate, popular religious believe in the area at the time of the life of an ancestor.

In another embodiment of the present invention, the presentation generation module 204 may further include weather data 216 for generating presentations. The presentation generation module 204 may further look up the weather from a weather database and generate a narrative on the weather in the city on the day an ancestor was born, including the temperature, the precipitation, etc.

In another embodiment of the present invention, the presentation generation module 204 may further include links to discover family trees 218 for generating presentations saved on a server. The family history researchers may discover other family trees that may be merged into their own. The user may be notified when a new tree is uploaded that matches one or more relatives in the user's family tree. The user may then view the presentation and see the new icons on the geobrowser and the new links appear in the presentation. Further, new links may appear in the presentation or on web pages that are referenced in the presentation. The output of the presentation may generate additional products besides a presentation 220 such as a book 222 or a DVD 224.

Geo-locations may be looked up so that later, when the user is viewing a presentation, the user can see the event locations on the geobrowser. When the user views a genealogy presentation, it may be forwarded and reversed with a scrollbar. Another scrollbar may also be used to go back and forth in time and see generations of families on the geobrowser, and see icons at various locations, representing people such as relatives and neighbors who lived in various times on the earth. In a preferred embodiment, the system 200 may further allow the user to update the presentation generation module 204 at any time either manually or automatically.

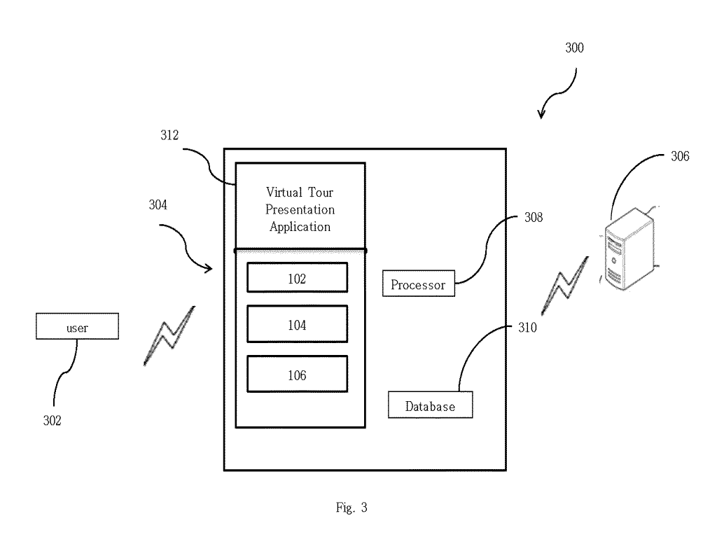

FIG. 3 is a schematic overview of the components in a network environment 300. The network environment 300 includes a user 302, a system 304 and a server 306. The system 304 is operated by the user 302 and communicates through the server 306. The system 304 is connected to a user's account through the server 306. The system 304 includes a processing device 308 and a database 310. The database 310 is use to store a virtual tour presentation application 312 and the processor 308 executes the virtual tour presentation application 312.

The virtual tour presentation application 312 includes at least one visual media module 102, at least one text module 104 and a geobrowser module 106. The one visual media module 102, the one text module 104 and the geobrowser module 106 are explained in detailed in conjunction with FIG. 1 of the present invention.

In another embodiment of the present invention, the presentation is broken up into time-frames. Time-frames may be assigned a name, so that a side-trip will always link to a named time-frame, even though new time-frames may later be inserted into the presentation. The length of each time-frame is the length of the audio in that time-frame. If there is no audio in that frame then the user determines the amount of time in that frame. The title of the presentation will be displayed during the playing of the presentation.

The foregoing discussion discloses and describes merely exemplary embodiments of the present invention. One skilled in the art will readily recognize from such discussion and from the accompanying drawings that various changes, modifications and variations can be made therein without departing from the spirit and scope of the invention.

1. A system for presenting content on a web browser comprising:
at least one visual media module, each allowing a user to present visual media content on a graphical user interface;
at least one text module for allowing said user to present text content associated with said at least one visual media module; and
a geobrowser module to show geolocations associated with any content in said at least one visual media module and said at least one text module.

2. The system according to claim 1 further comprising an audio module to provide audio associated with either said at least one text module or said at least one visual media module.

3. The system according to claim 1 further comprising one or more control buttons to control either said at least one text module or said at least one visual media module, wherein said one or more control button includes a forward button, a backward button, a slide-bar, an audio button, a grow and shrink button.

5. The system according to claim 1 wherein said geobrowser module further comprises a three-dimensional geobrowser such as provided by the google earth plugin, a two-dimensional geobrowser such as provided by google map, a satellite map, or a combination thereof.

6. The system according to claim 1 further comprising a chat module to allow said users to interact with each other over the network.

7. The system according to claim 1 further comprising a genealogy module to create genealogical presentations from various sources of data, including data provided by said user.

8. The system according to claim 1 further comprising a side-trip presentation module for allowing users to see other stored side-trip presentations.

9. A system for presenting content over a server, said system comprising:
a processor; and
a memory coupled to said processor, said memory to store a virtual tour presentation application executed from said processor, wherein said virtual tour presentation application comprises of:
at least one visual media module, each allowing a user to present visual media content on a graphical user interface;
at least one text module for allowing said user to present text content associated with said at least one visual media module; and
a geobrowser module to show geolocations associated with any content in said at least one visual media module and said at least one text module.

10. The system according to claim 9 further comprising an audio module to provide audio-associated with either said at least one text module or said at least one visual media module.

11. The system according to claim 9 further comprising one or more control buttons to control either said at least one text module or said at least one visual media module, wherein said one or more control button includes a forward button, a backward button, a slide-bar, audio button, an audio button, grow and shrink button.

12. The system according to claim 9 wherein said geobrowser module further comprises a three-dimensional geobrowser such as provided by the google earth plugin, a two-dimensional geobrowser such as provided by google map, a satellite map, or a combination thereof.

13. The system according to claim 9 further comprising a chat module to allow said users to interact with each other over the network.

14. The system according to claim 9 further comprising a genealogy module to create genealogical presentation on the data provided by said user.

15. The system according to claim 9 further comprising a side-trip presentation module for allowing users to see other stored side-trip presentations.

16. A method for presenting content comprising:
presenting a visual media content on a graphical user interface through at least one visual media module;
presenting at least one text content associated with said at least one visual media module; and
associating a geobrowser module to show geolocations associated with any content in said at least one visual media module and said at least one text module.

17. The method for presenting content according to claim 16 further comprising the step of associating an audio module to provide associated with either said at least one text module or said at least one visual media module.

18. The method for presenting content according to claim 16 further comprising the step of providing a side-trip presentation module for allowing users to see other stored side-trip presentations.

19. The method for presenting content according to claim 16 further comprising the step of providing a chat module to allow said users to interact with each other over the network.

20. The method for presenting content according to claim 16 further comprising the step of providing a genealogy module to create genealogical presentation on the data provided by said user.
